(19) United States
(12) Patent Application Publication
(10) Pub. No.: US 2016/0325742 A1
(43) Pub. Date: Nov. 10, 2016

(54) Active Monitoring and Crash Mitigation System for Race Vehicles

(71) Applicant: Scott Behrens, Noblesville, IN (US)

(72) Inventor: Scott Behrens, Noblesville, IN (US)

(21) Appl. No.: 14/704,016

(22) Filed: May 5, 2015

(51) Int. Cl. B60W 30/085; B60Q 9/00

(52) U.S. Cl. CPC B60W 30/085; B60Q 9/008; B60W 2520/00

(57) ABSTRACT

An active monitoring and crash mitigation system and method for race vehicles. Various sensors are connected directly or wirelessly as inputs to a control module that monitors vehicle and track characteristics to determine if an accident is imminent or has occurred. Programmable criteria in the control module determine whether corrective action is needed and the best course of action for avoiding hazards. Corrective action is achieved by triggering devices that alter the vehicle's speed, lift forces, and down forces. The corrective actions force the vehicle back to the ground and/or reduce its speed to reduce the seriousness of an incident. Indicators notify the driver of the imminent or current deployment of corrective action, an accident, and/or the relative safety of various paths forward. Various implementations of this system and method reduce and/or eliminate race vehicles from reaching a catch fence, barrier, or other objects that pose great risk to both the driver and spectators.

### CROSS REFERENCE TO RELATED APPLICATIONS

This application claims priority benefit of U.S. Provisional Application Ser. No. 61/990,432, filed May 08, 2014; Titled: Active monitoring and crash mitigation system for race vehicles; the contents of which are hereby incorporated by reference.

### FIELD OF THE INVENTION

This system and method relates to the field of race vehicle safety. More specifically, it comprises a system and method for detecting a vehicle's potential for crashing, notifying the driver of this potential, and then inducing forces on the vehicle via direct and indirect means to keep it on the ground and reduce speed of impact. Furthermore, the system may be'linked with other vehicle systems and/or a master monitoring and control system to share information and commands in order to improve accident avoidance.

### BACKGROUND OF THE INVENTION

There are many known devices for detecting the need for and then affecting these forces or applying other forces on a vehicle for an intended safety purpose. One example is the flaps on the hood and roof of racing cars that automatically open when a vehicles turns sideways. These flaps change the forces on the vehicle in an attempt to prevent them from spinning completely around thus minimizing the chance for air to get under the vehicle and lift it off the ground. These flaps typically are actuated by airflow and pressure differentials such that they are not an externally controlled device. Additionally, these flaps require that the vehicle has changed direction significantly such that they may respond.

Another example would be parachutes on drag vehicles. The chutes are manually actuated to deploy out of the rear of the vehicle with the intended purpose to slow the vehicle down, most commonly at the conclusion of a race. These parachutes are not automatically released and must be triggered by the driver manually.

A more recent example would be the rear bumpers on open-wheel racing cars in the Indy Car series. These bumpers are intended to prevent wheel-to-wheel contact, which has been identified as a major cause for vehicles to go airborne. While bumpers reduce the wheel-to-wheel contact that can lead to airborne vehicles, they do not address other causes.

In recent years, racing has seen larger and more dangerous wrecks. A number of these wrecks have resulted in vehicles going off course or airborne and crashing into the catch fences. Catch fences are used as a method to contain a vehicle (and its parts) that goes off course or become airborne. When the vehicle hits this catch fence, it breaks into several pieces, some of which go through or over the fence. In these circumstances the driver and the audience are exposed to great risk of injuries and/or death.

Existing technology consists of mechanical flaps, bumpers, constraint systems, or mechanically actuated devices like parachutes and brakes. These devices do not perform adequately as vehicles are still going off course or airborne at high speed. Additionally, technologies such as flagmen and electronic light systems often do not provide adequate accident avoidance.

Therefore there is a need for a better system and method that combines sensors/inputs and devices/communication to intelligently avoid accidents and/or alter the forces on a vehicle to prevent it from going airborne and/or reduce the speed of impact, thereby preventing or at least reducing the damages and injuries/deaths accompanying such accident/incidents.

### SUMMARY OF THE INVENTION

The present system and method combine sensors/inputs and devices/communication to intelligently avoid accidents and/or alter the forces on a vehicle to prevent it from going airborne and/or reduce the speed of impact. Sensors attached to the vehicle monitor various characteristics of the vehicle such as, but not limited to: elevation from course surface, speed, aerodynamic pressure, course location, loft, roll, deceleration, shock travel, crash sensors, and change in directional orientation. These sensors feed information to a variety of information and control systems, both on and off the vehicle, and their programmed software that compares the data against pre-established and real-time developed criteria. If the data from the sensors is outside of programmable ranges, the various systems responds by notifying the driver and actuating devices that affect speed and/or forces on the vehicle. Communications from other vehicles and/or a remote master monitoring control system can provide additional inputs to the various on-board systems that can either determine, or respond to a external to the vehicle, and command trigger responses and/or notify the driver of action to take, course conditions, and the like.

These corrective forces are primarily, but not limited to, speed limits, down-force, lift, and drag. The forces can be achieved by changing the angle of wings on the vehicle, opening flaps, actuating airbrakes, deploying a parachute, inflating an airbag, engine rev limiting, or automatically applying the vehicle brakes. An example is the automatic change in angle of the front wings of the car to generate higher down-forces, thus pushing the front of the vehicle back to the ground. Another example is the deployment of a parachute from the rear of the vehicle, which slows the vehicle and prevents the vehicle from flipping end-over-end.

The criteria for actuation or deployment of the devices are programmable and adjustable; the actuation can be either taken on an individual system basis, in conjunction with other passive or self-adjusting systems, or in a concerted response across several coordinating systems. In the present invention, such actions can be either taken before, as or after a detectable issue arises; however, in the case of the present invention, they are preferentially configured to trigger before the forces of lift exceed the down forces on the vehicle. Additional or alternative criteria are set to trigger in events where the vehicle does not go airborne, but loses control and goes off course. Still other criteria could include; in various embodiments, car-to-car and/or remote master monitoring and control system communications where a vehicle is notified of an incident and its location(s) on the course in an effort to avoid it and/or force the notified vehicle to respond (such as by imposition of a speed/engine rev limit).

Sensors related to vehicle speed and location could also be used to alter the reaction of the remote or local control system; in the case of the present invention, by communicating with a remediation control module. An example would be the speed of the vehicle: if the speed was below the threshold for lift generated by air or below a threshold that prevents injuries, the control module would not respond to the criteria that would otherwise apply to outputs of other sensors. Similarly, the location of the vehicle could trigger or prevent the control module from responding; an off-path location could be set to automatically trigger the control module, while a location known to not be of concern could prevent response by the control module.

In some implementations, indication is given to vehicle drivers/operators in addition to, or instead of, the remediation equipment installed on the vehicle. For example, the system might notify the driver of proximity to a dangerous situation or incident and furthermore guide them away to avoid impact by providing guidance instructions.

### BRIEF DESCRIPTION OF THE DRAWINGS

The present invention is further detailed with respect to the following drawings. These figures are not intended to limit the scope of the present invention but are instead to illustrate certain, but not all, attributes of the invention.

FIG. 1 is a diagram of how devices are connected in the illustrated example system.

FIG. 2 is a side view of a vehicle showing the loft angle and associated forces.

FIG. 3 is a front view of a vehicle showing the angle of roll.

FIG. 4 is a view of a vehicle in the air showing possible sensor locations.

FIG. 5 is a view of a vehicle with a deployed parachute and flaps.

FIG. 6 is an illustration of vehicles on a course with location boundaries.

FIG. 7 is a flow diagram of one approach for logic sequence in the control module.

### REFERENCE NUMERALS IN THE DRAWINGS

The present invention is further detailed by providing below a table of the numerals used in the figures described above along with a short title for each. These figures and associated numerals are not intended to limit the scope of the present invention but are instead to illustrate certain, but not all, attributes of the invention.

| | | | | | |
|---|---|---|---|---|---|
| 10 | control module | 11 | power sources | 12 | sensor(s) |
| 13 | device(s) | | | | |
| 20 | vehicle | 21 | vehicle weight | 22 | rear wheel height |
| 23 | front wheel height | 24 | loft angle | 25 | down force |
| 26 | lift force | | | | |
| 30 | left side wheel | 31 | right side wheel | 32 | roll angle |
| | height | | height | | |
| 40 | diffuser sensor | 41 | left side height | 42 | rear height sensor |
| | | | sensor | | |
| 43 | right side height | 44 | front height | | |
| | sensor | | sensor | | |
| 50 | parachute | 51 | front wing | 52 | flaps/airbrakes |
| 53 | rear wing | | | | |
| 60 | course | 61 | disabled area | 62 | deployment area |
| 63 | off-course position | 64 | on curb position | 65 | inside edge |
| 66 | outside edge | | | | |

### DETAILED DESCRIPTION OF THE INVENTION

Various embodiments are described more fully below with references to drawings, but not all embodiments are shown in figures. The present disclosure may be embodied in many forms or combinations and should not be construed as limited to the embodiments described below.

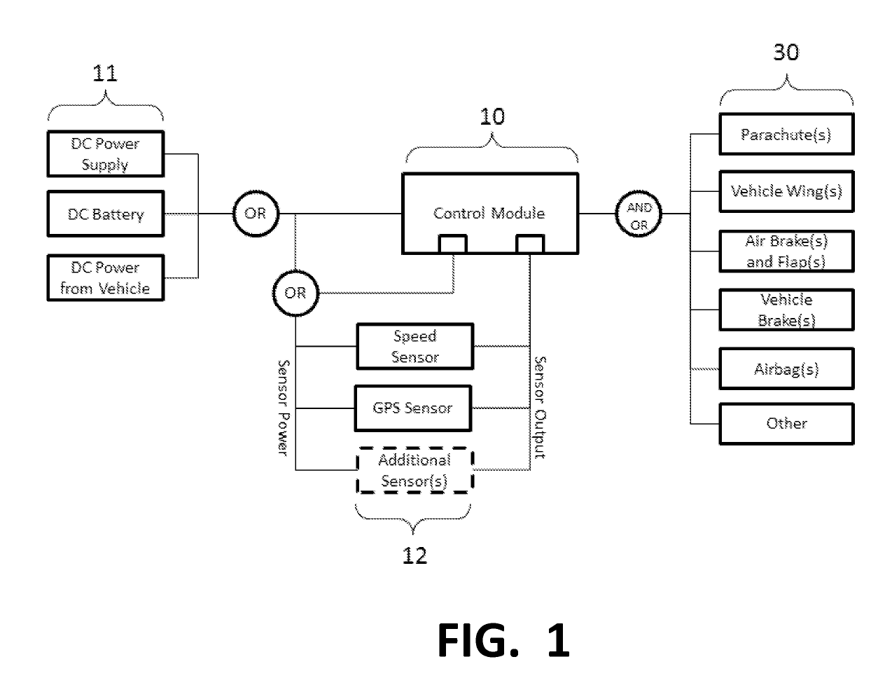

FIG. 1 shows one approach for connecting system components together. The control module 10 is optionally powered by one or more power sources 11. The power sources 11 may be in the form of a power supply, battery, or vehicle power. The power from these devices may directly or indirectly power the sensors 12 that monitor characteristics of the vehicle 20. The control module 10 analyzes data from the sensors 12 and uses some of the data to calculate characteristics of the vehicle 20 such as loft angle 24 and roll angle 32. The data from the sensors 12 and or the calculated characteristics are compared against criteria inside the control module 10.

The criteria are fixed or programmable set points or ranges that the control module 10 compares against the current data received from the sensors 12. If current data is outside of a set point or allowable range then the control module 10 will trigger devices 13 that affect the forces on the vehicle 20. The devices 13 that are employed may include but are not limited to one or more of the following: parachute(s) 50, front wing(s) 51, flap(s) & airbrake(s) 52, rear wing(s) 53, automatic application of the vehicle brakes, and air bag(s). Additionally, there may be circumstances when the driver of the vehicle 20 wishes to manually trigger these devices and may optionally do so with a button or other devices located near the driver.

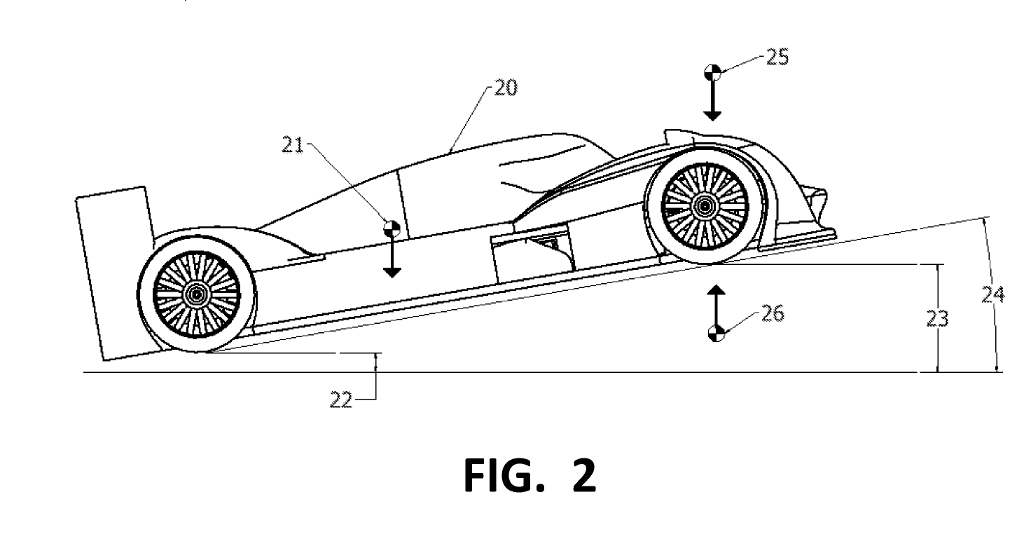

FIG. 2 illustrates one circumstance that the control module 10 would be programmed to account for. In this circumstance the front wheel height 23 is greater than the rear wheel height 22. This situation can occur in many ways such as: contact with another vehicle or debris, hitting a curb or other bump on or off the course 60, coming over a hill, or failure of a vehicle component(s). The control module 10 may calculate a loft angle 24 by using vehicle height data from the rear height sensor 42 and front height sensor 44. Optionally, the control module 10 may utilize other sensors 12 such as a gyro, altimeter, and or accelerometers to determine the loft angle 24. The control module 10 will compare the loft angle 24 against criteria for maximum allowable loft. The maximum allowable angle would be set for an angle in which the lift force 26 generated by air pushing on the bottom of the vehicle 20 is less than the combination of the vehicle weight 21 plus the down force on the vehicle 20. When the loft angle 24 reaches the maximum allowable angle the control module 10 would trigger one or more devices 13. The devices triggered will affect the forces on the vehicle 20 to force the vehicle 20 back down onto the course 60.

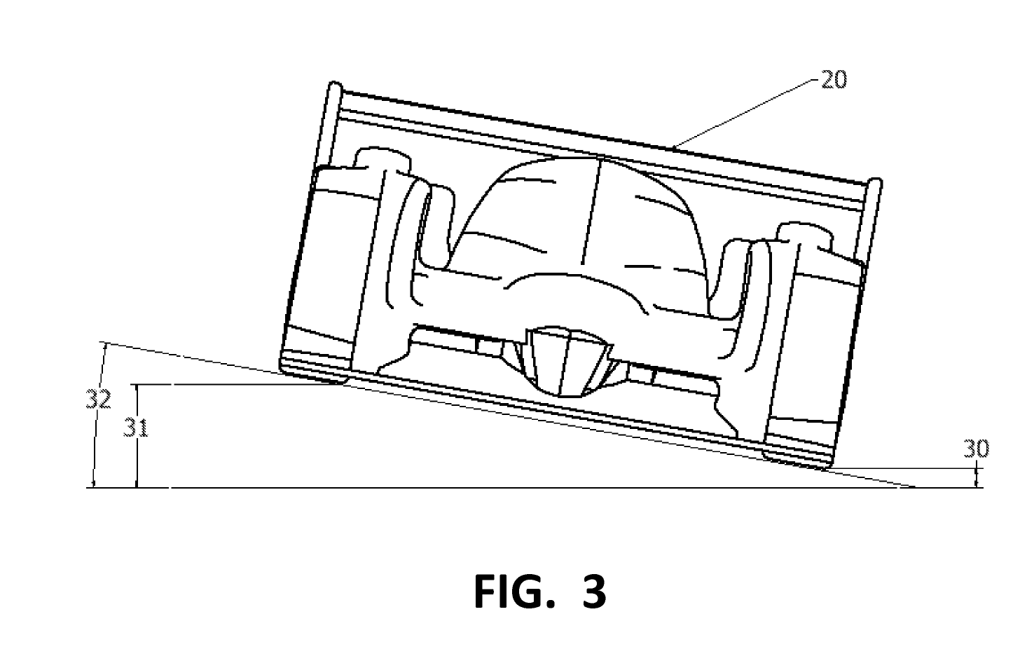

FIG. 3 illustrates another circumstance that the control module 10 could optionally be programmed to account for. In this circumstance one side of the vehicle 20 is raised off of the ground. The specific example illustrated shows the right side wheel height 31 is higher than the left side wheel height 30. This situation can occur in many ways such as: contact with another vehicle or debris, hitting a curb or other bump on or off the course 60, or other situation. The control module 10 may calculate the roll angle 32 by using height data from the left side height sensor 41 and right side height sensor 43. Optionally, the control module 10 may utilize other sensors 12 such as a gyro, altimeter, and or accelerometers to determine the loft angle 24. The control module 10 will compare the roll angle 32 against criteria for maximum allowable roll. When the roll angle 32 reaches the maximum allowable angle the control module 10 would trigger one or more devices 13. The devices triggered will affect the forces on the vehicle 20 to force the vehicle 20 back down onto the course 60.

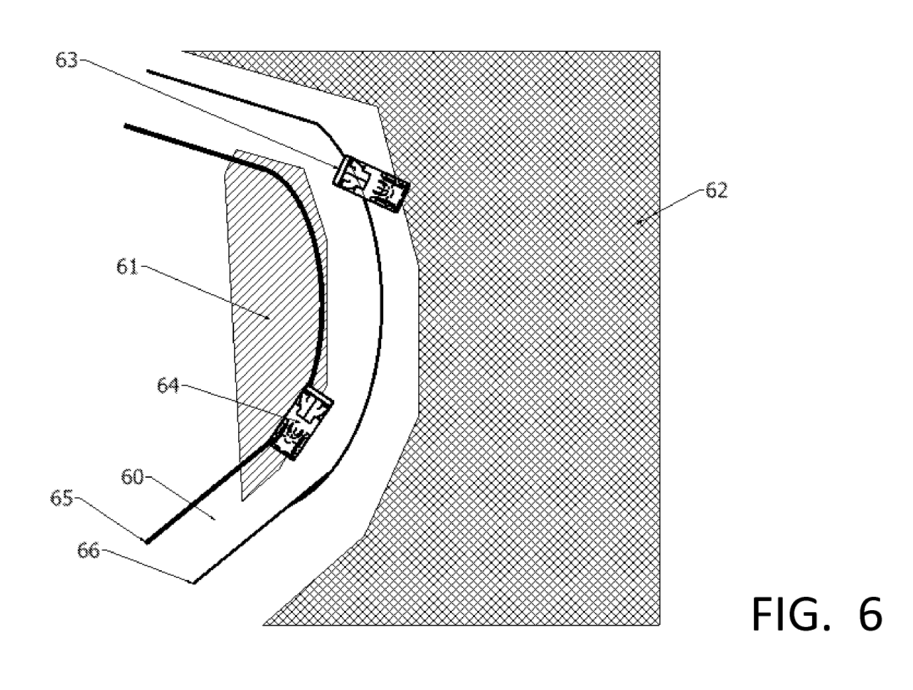

FIG. 6 illustrates another circumstance that the control module 10 could optionally be programmed to account for. In this circumstance the vehicle 20 is entering an off-course position 63 as determined by a sensor 12. Various sensors 12 may be used to determine location such as, but not limited to, a GPS. The location is constantly monitored by the control module 10 to determine if the vehicle 20 enters a deployment area 62. When the vehicle 20 enters a deployment area 62 the control module 10 will trigger one or more devices 13 which will affect the forces on the vehicle 20 to slow it down and/or keep it on the ground. The deployment area 62 would be set at some distance from the inside edge 65 and/or outside edge 66 of the course 60. Additional locations not associated with an edge of the course 60 could optionally be monitored.

FIG. 6 also illustrates another optional feature the system may have. It shows the vehicle 20 in an on-curb position 64. This is a common occurrence in racing that causes the vehicle 20 to bounce and roll. In this circumstance it would be undesirable for the control module 10 to trigger a device 13. The system may employ a sensor 12 that monitors the location of vehicle 20 via a GPS of other suitable method. The control module 10 would constantly monitor vehicle 20, and if the vehicle 20 enters a “disabled area” 61, it would not trigger a device 13 regardless of sensor 12 data. The disabled area 61 would be set at some distance from the inside edge 65 and or outside edge 66 of the course 60. Additional locations not associated with an edge of the course 60 could optionally be monitored.

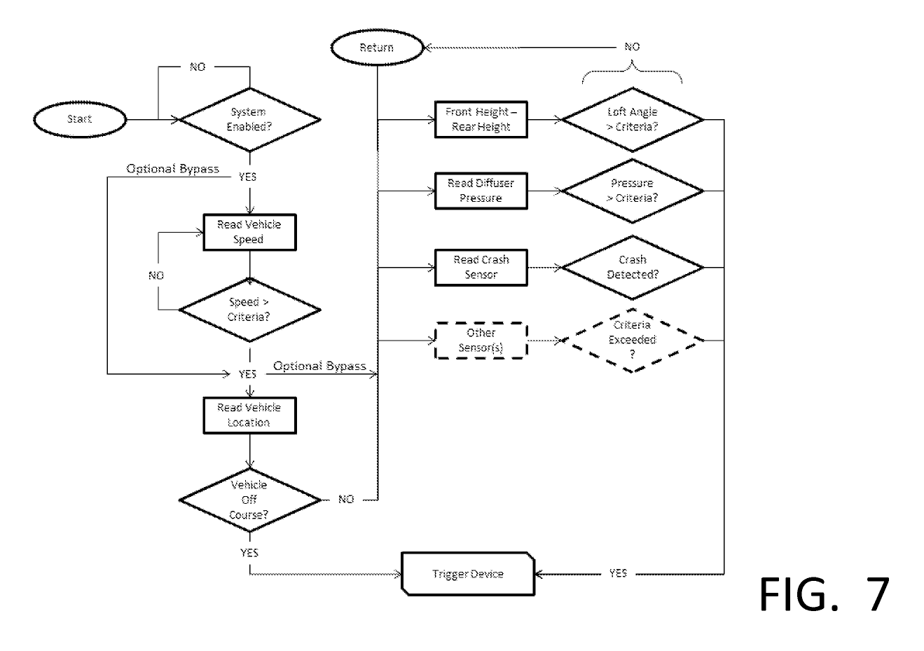

The control module 10 employs one or more sensors 12 to determine when one or more devices 13 should be triggered. Depending on the circumstance, sensors may be used individually or in combination; as illustrated in FIG. 7, which illustrates one approach for a logic sequence. These sensors 12 may include but are not limited to those described below.

A sensor 12 that determines vehicle location such as a GPS can be used as described above to automatically trigger a device 13 or prevent a trigger of a device 13 by the control module 10.

A sensor 12 that monitors vehicle speed may be employed to disable the system at lower speeds that pose a lower risk of incident.

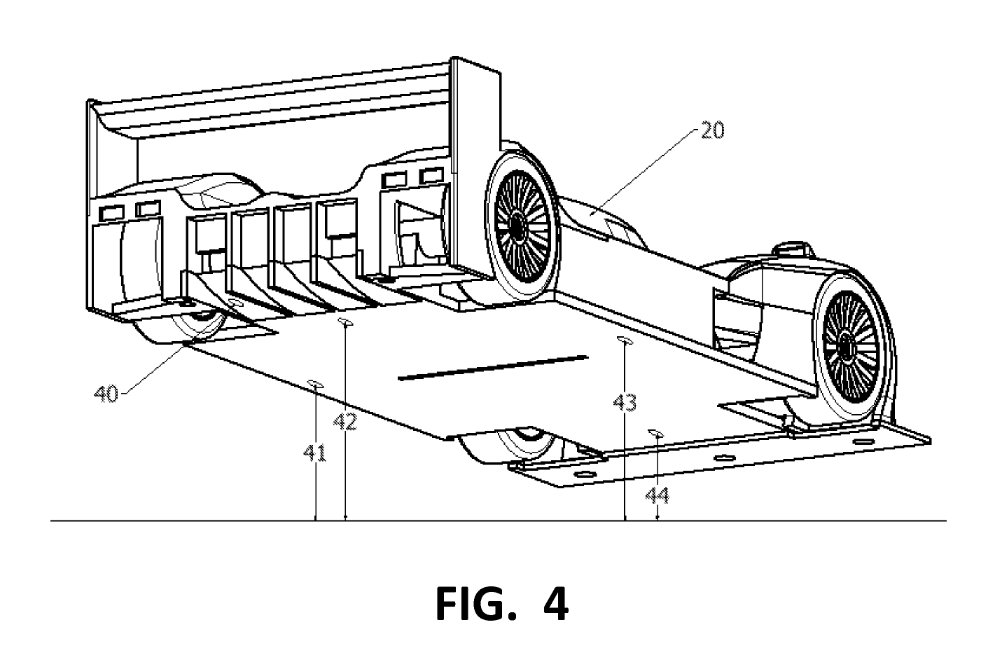

A sensor 12 that monitors height of the vehicle 20 in various locations, as shown in FIG. 4, may be used to determine roll angle 32, loft angle 24, and other criteria to trigger a device 13.

A sensor 12 that monitors pressure may be employed in one or more locations on vehicle 20, such as a diffuser sensor 40 shown in FIG. 4. Diffuser sensor 40 will detect negative pressure when the vehicle 20 is at speed due to the shape of the vehicle 20 body. If the vehicle 20 were to lift off of the ground this sensor would see a change in pressure and this change could be used to set criteria in the control module 10 to trigger a device 13.

In some embodiments, a sensor 12 that detects changes in airflow or pressure by means of a mechanical flap, similar to those on some race cars, sends an electronic signal to the control module 10. These flaps automatically change position when the air flow or pressure changes on the vehicle 20 in a manner that is known to be of issue. When one or more of these flaps change position, the control module 10 is programmed to trigger a device 13.

A sensor 12 that detects rotation and/or angle such as a gyroscope or accelerometer may be employed to detect sudden changes in speed and or direction, roll angle 32, loft angle 24 and other vehicle 20 characteristics. The control module 10 may use this data to trigger one or more devices 13.

A sensor 12 that detects a crash, similar to those in street cars, may be employed as an input to the control module 10. When a crash is detected, the control module 10 is programmed to trigger one or more devices 13.

Additional sensors associated with the vehicle 20 such as shock extension and retraction, brake status, engine status, body damage, fire, and other sensors that will occur to those skilled in the art serve as additional inputs into the control module 10.

The control module 10 triggers devices 13 to affect the forces on the vehicle 20 for the intended purpose to force it back to the ground, keep it on the ground, and or slow it down to minimize collision impact and minimize potential for the vehicle 20 to go airborne. By keeping the vehicle on the ground and slowing it down the seriousness of a crash is reduced. To achieve the reduction in speed and/or keeping the vehicle 20 on the ground, one or more devices are triggered. These devices include, but are not limited to, one or more of the devices described below.

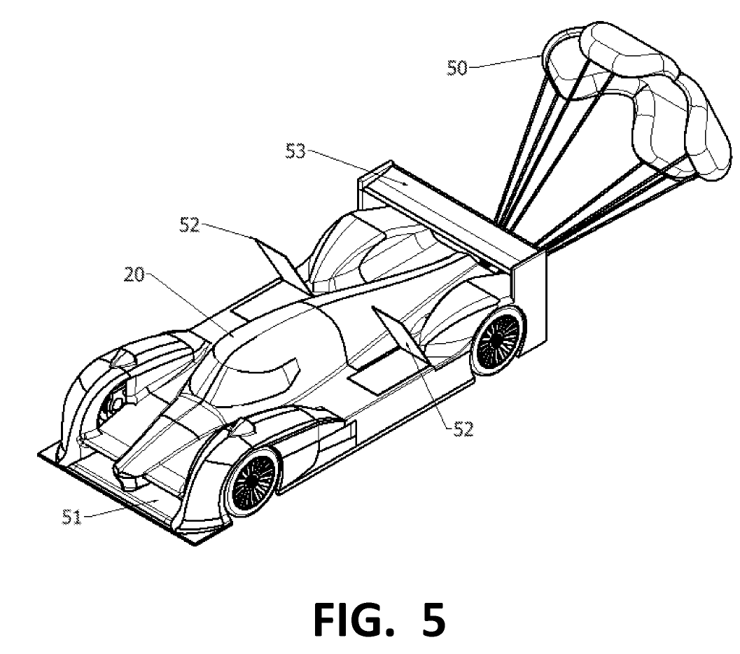

A device 13 may include the deployment of a parachute 50 from the vehicle 20. FIG. 5 illustrates one approach in which the parachute 50 exits the rear of the vehicle 20. The parachute 50 reduces the speed of the vehicle 20 and changes the forces exerted on the vehicle 20 such that it is brought back to the ground after detecting a loft angle 24 that is equal to or exceeds the maximum angle allowed. The parachute 50 may also be deployed under one or more of the circumstances described previously.

A device 13 may include flaps or airbrakes 52 that open from one or more locations on the vehicle 20, as shown in FIG. 5. Flaps or airbrakes are aerodynamic features that move to alter air flow patterns, pressures, and drag on a vehicle. Flaps could be designed to increase down force 25 and/or reduce lift force 26 and/or increase drag on the vehicle 20.

A device 13 may include altering the angle of wings or body panels on the vehicle to adjust the down force 25 and/or lift force 26 and/or drag on the vehicle 20, as shown in FIG. 5. For example, increasing the angle of the front wing 51 would increase the down force 25, which would push the front of the vehicle 20 down. Similarly, increasing the angle of the rear wing 53 would increase down force 25 and would also increase drag, which would slow the vehicle 20.

A device 13 may include the vehicle's 20 braking system. The control module 10 could be designed to trigger the brakes to assist in braking and slowing of the vehicle. This would be particularly applicable if the driver's feet were to come off the brakes for any reason.

A device 13 may take other forms, such as airbags, detachable panels, or other means of achieving the desired effect, as will occur to those of ordinary skill in the art.

A device 13 is triggered by the control module 10. The trigger refers to the action of releasing the device 13 to perform its purpose. The trigger may take several forms such as, but not limited to: propellant or ballistics to release a parachute 50 or airbag at high speed, springs and/or actuators to open air brakes 52 or flaps or body panels, latches to hold flaps or body panels closed unless triggered, actuators and/or motors to change front wing 51 and/or rear wing 53 orientation.

In variations of these embodiments of the invention, control module 10 also takes as inputs real-time information transmitted wirelessly from other vehicles and/or a master control system.

In various implementations of systems according to the disclosure, one or more indicators notify the driver of a dangerous condition or incident and provide proximity and/guidance to avoid the location. The guidance may be in the form of a visual indication of proximity and/or a left-to-right indication of a safe path in contrast with a dangerous path. One implementation is a visual display that shows either the left, middle, and or right portions of the track blocked with the not blocked portions of the course showing clear.

As a further example of an embodiment example, in FIG. 7 is a flow diagram of one of many possible logic sequences that could be employed. Alternatives to the selected sensors 12, devices 13, control modules 10, and power supplies 11 would not materially alter the nature of the system and method. One example is that the control module 10 could be an electronic device, electrical relay system, a combination mechanical and electrical system, general-purpose or special-purpose processor, ASIC, controller or other controller.

While the present invention has been shown and described in its various implementation embodiments herein, it will be understood by those skilled in the art that various changes in form and detail may be made therein without departing from the spirit and scope of the present invention.

The invention claimed is:

1. An active monitoring and accident mitigation system and method for race vehicles that responds to a vehicle's physical attitudinal status by modifying the forces on the vehicle to keep it on the ground and/or reduce its speed that includes:
at least one or more sensors that provide data for a vehicle's physical attitudinal status,
at least one or more devices that alter the forces on a vehicle,
at least one local control module that compares sensor data to attitudinal criteria,
at least one local and/or remote monitoring system that provides oversight to the local control module, and
at least one local control module that provides one or more actionable signals to one or more attitudinal and air forces management devices.

2. The vehicle of claim 1 may take the form of a car, truck, boat, motorcycle, and other modes of transportation used in racing.

3. The devices of claim 1 that act on the vehicle in a manner that the net attitudinal forces on the vehicle minimize the potential for the car to go airborne, while assisting in returning it to the ground and/or to reduce the vehicle's speed via either triggered or deployed devices, solely, or in coordination with other active and passive devices, that alone, or in combination, employ or induce various resultant forms of air action, including, but not limited to, downdraft, side draft and drag.

4. The devices of claim 3 that act upon the vehicle that may take the form of parachute(s), flap(s), wings, wings that change position, airbags, and/or controlled application of the vehicle braking systems, alone or in conjunction with other on-board systems.

5. The sensors of claim 1 that detect one or more characteristics of the vehicle including loft, angle, pressure, distance, structural stress, vehicle location, speed, and or change in direction.

6. The sensors of claim 5 that can be mechanical or electronic and may be on-board the vehicle or in its proximity, such as on other vehicles or in or around the course and its racetrack.

7. The mechanical sensor of claim 6 that may take the form of pressure plates that switch state based on a pressure, a flap that changes position, or a physical device that detects damage.

8. The electronic sensor of claim 6 that may take the form of instruments that include, but are not limited to, those that measure air pressure under the vehicle, distance of the vehicle from the ground, angular momentum sensed by an accelerometer, or gyroscopic inputs.

9. Information systems, using a variety of presentation methods, including, but not limited to gauges, lights, flat panel displays, and the like, on a vehicle of claim 1 that alert a driver just before or when a corrective vehicle physical attitudinal action is or is about to be taken, or that a hazard is present on the track, and how to avoid it or minimize its effect.

10. Data that is obtained from the one of more sensor(s) of claim 1 that is interpreted by a local and/or a remote software system, operating in either a local or remote computing hardware system, or both, in the combined form, a control module, that compares the information against stored, or real-time developed, vehicle physical attitudinal status criteria appropriate to the vehicle's current status.

11. A control module of claim 10 that may take the form of mechanical linkage, electrical circuits, pneumatic and/or hydraulic circuits, or electronic systems.

12. The electronic control module of claim 10 that may take the form of programmable circuitry that compares sensor data to criteria and then triggers an output to a secondary device that responds.

13. The sensor data of claim 10 that may be from sensors on the vehicle, on another vehicle, or in or around the course and its racetrack.

14. The criteria of claim 10 that are fixed or configurable values that are compared against the data from one or more sensors to determine when devices should be actuated or deployed.

15. The criteria of claims 12, 13, or 14 that may be fixed or can be dynamically changed based on conditions such as vehicle speed and location.

16. The location-based criteria of claim 15 that may be programmed to ignore data from areas of a course with known disturbances to a vehicle, such as a curb that bounces it off the ground.

17. The location-based criteria of claim 15 or 16 that may also be used to trigger the system when a vehicle is detected to be off course.

18. The speed-based criteria of claim 16 that may be used to enable or disable the system for speeds above or below a specified value.

19. The devices of claim 3 that may also be triggered by the driver of the vehicle.
